(19) United States
(12) Patent Application Publication
(10) Pub. No.: US 2025/0133362 A1
(43) Pub. Date: Apr. 24, 2025

(54) PROCESSING SYSTEM OF A STEREO ACOUSTIC SIGNAL

(71) Applicant: HI - TECH SOLUTIONS S.R.L., Foligno (Perugia) (IT)

(72) Inventor: Cesare MATTOLI, Foligno (Perugia) (IT)

(21) Appl. No.: 18/835,149

(22) PCT Filed: Feb. 16, 2023
(86) PCT No.: PCT/IB2023/051399

§ 371 Date: Aug. 1, 2024

(30) Foreign Application Priority Data
Feb. 17, 2022 (IT) 102022000003005

(51) Int. Cl. H04S 7/00

(52) U.S. Cl. CPC H04S 7/303

(57) ABSTRACT

System for processing a stereo acoustic signal including: a first input and a second input, a first output and a second output, a first summing block connected to the first input and to the first output, a second summing block connected to the second input and to the second output, a first delay block connected to the first input and to the second summing block, and a second delay block connected to the second input and to the first summing block.

The present invention relates to a processing system of a stereo acoustic signal suitable for being sent to an acoustic headphone so that the signal heard by the user wearing the headphone is as similar as possible to an ideal listening obtained with two or more speakers in an anechoic listening room.

As it is known by all users who are accustomed to listening to acoustic signals—such as a music piece—using headphones, regardless of being professional users, audiophiles, sound operators, etc., the perception of a music piece using headphones is different from the perception obtained without headphones from two or more speakers in a listening room.

In the case of basic stereophony with two speakers, the main reason for the difference between the signal perceived in the headphones and the signal perceived from two speakers is that the acoustic signal coming from the left speaker reaches the left ear first and the right ear after a time interval. Such a time interval is due to the propagation of the sound in the space between the left ear and the right ear.

The same phenomenon occurs for the sound emitted by the right speaker, which reaches the right ear first and then the left ear.

So, in the case of two speakers and one listener, a direct acoustic signal from the left speaker and a delayed acoustic signal from the right speaker reach the left ear. A direct acoustic signal from the right speaker and a delayed acoustic signal from the left speaker reach the right ear. In contrast, in the case of headphone listening, the sound reproduced by the right earpiece and by the left earpiece is perceived by the right ear and by the left ear of the user without any delay.

Such a phenomenon was analyzed as early as the 1960s (Robert Larson, and John Eargle, Audio Magazine November 1962). A more articulated electronic system capable of improving the headphone listening, which is still adopted in the market, was devised and published by Engineer Siegfried Linkwitz, in “Improved Headphone Listening” in “Audio Magazine, December 1971”. Said system was improved over the years, but it is based on experimental empirical principles and intuitions.

The document by Siegfried Linkwitz describes a device suitable for being disposed between a sound source and a headphone. Such a device comprises two delay blocks in such a way to impose a delay of the sound signal toward the right earpiece and the left earpiece of the headphone. The delay blocks are R-C resonators, that is to say resonant circuits made with resistors and capacitances that generate a delay that varies as the frequency of the signal varies. As a result, different delays will be obtained in the case of low-frequency or high-frequency signals, at the expense of a high fidelity of sound reproduction.

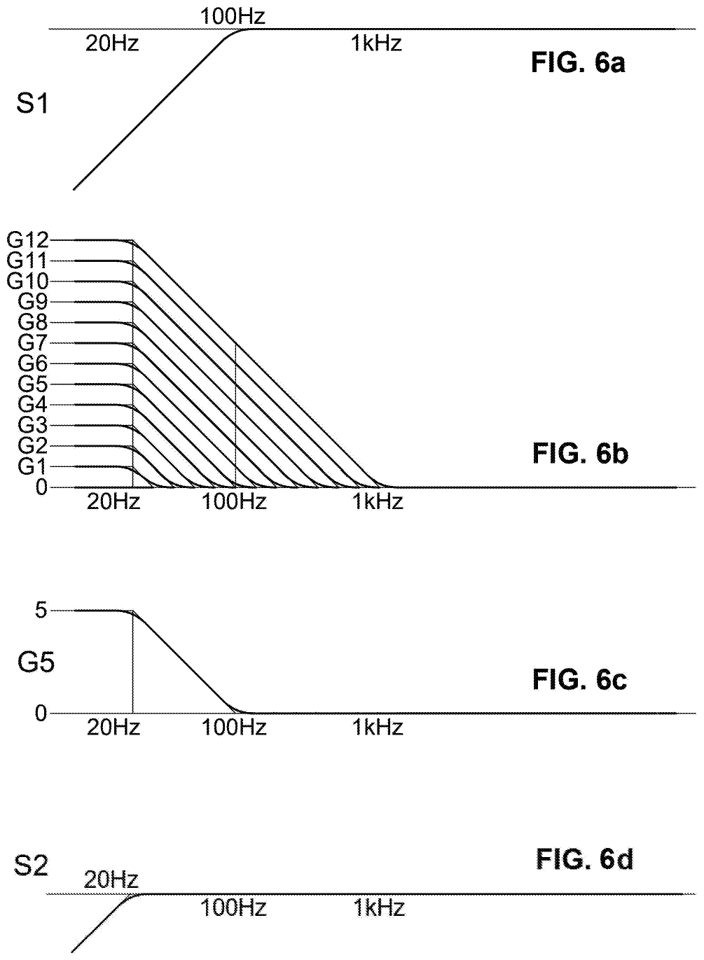

In “Improving to Stereo Headphone Sound Image”, Thomas M. V. describes a device suitable for being disposed between a sound source and a headphone. Such a device comprises two delay blocks in such a way to impose a delay of the sound signal towards the right earpiece and towards the left earpiece of the headphone. The delay blocks are set in such a way to maintain a constant phase of the signal. In order to maintain the constant phase of the signal, the delay must vary as the frequency of the signal varies. FIG. 6 of said document shows that the delay varies as the frequency varies and decreases for frequencies above 4 kHz. As a result, such a device does not ensure a high fidelity of sound reproduction at high frequencies above 4 KHz.

“Improved Externalization and Frontal Perception of Headphone Signals” by Weinrich, Soren Gret describes a device suitable for being disposed between a sound source and a headphone. Such a device comprises two delay blocks in such a way to impose a delay of the sound signal towards the right earpiece and towards the left earpiece of the headphone. The document does not disclose how the delay of each delay block is calculated, and certainly the document does not describe or suggest any relationship between the delay and the position of the speakers relative to the user wearing the headphone. The document says that the delay of a block is comprised between 50 μs-2000 μs. Such a wide range would rule out the fact that the delay is calculated based on the inclination angle of the speaker relative to the listener. In fact, assuming that the inclination angle of the speaker with respect to the listener is 90°, such as to give the maximum delay value, in order to have a delay of 2000 μs, the distance between the earpieces would have to be about 68 cm, which is obviously illogical, since the distances between two earpieces generally range between 15 cm and 18 cm.

There are other phenomena that may cause other differences between listening with headphones and listening without headphones, such as the internal reflections in the listening room, the high-power signals that enter the nasal cavities, or the low-frequency signals that make the stomach or the bones vibrate.

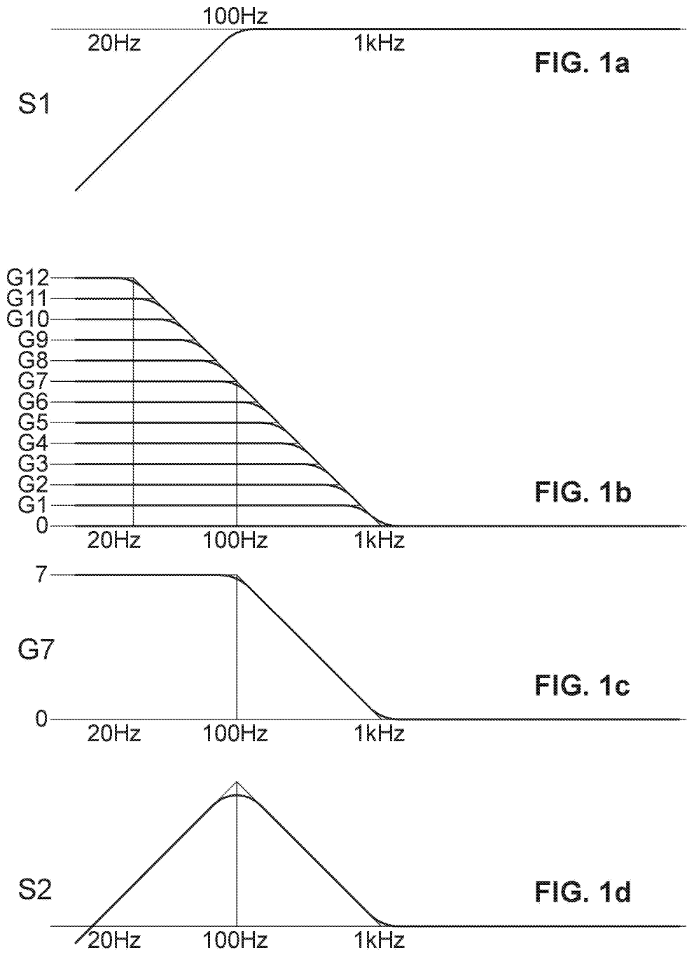

In music pieces from the 1960s, when the high-fidelity techniques were not advanced in the recording studio, the low-frequency sound is often deficient. FIG. 1a shows a possible distribution of a sound (S1) coming from a music piece from the 1960s with a typical deficiency of frequencies below 100 Hz.

In order to solve such a drawback, a tone control known as “Baxandal” is known, which is found in the majority of the audio amplifiers and allows for enhancing or attenuating the sound in two or more frequency bands of the audio signal.

The Baxandal tone control has an adjustable knob to select the frequency band in which to enhance the sound. Depending on the position of the knob, the Baxandal tone control has a response in the enhancement of the sound at low frequencies of the type depicted in FIG. 1b. FIG. 1b shows a family of 12 Bode plots as a function of the position of the knob. Specifically, the knob has 12 positions. Said Bode plots are transfer functions (G1, . . . . G12) of the first order (6 db/octave) characterized by a variable-frequency pole and a fixed zero at an average frequency, for instance 1 kHz.

If the knob is moved in such a way to enhance the frequencies below 100 Hz, the G7 transfer function shown in FIG. 1c with a pole at 100 Hz is selected from the transfer functions of the diagram of FIG. 1b. Otherwise said, a transfer function having a pole at 100 Hz, a zero at 1 KHz and a resulting gain of 20 dB at the position 7 of the knob is selected. Thus, a filter with the transfer function G7 is generated.

However, by multiplying the distribution of the sound (S1) of FIG. 1a by the G7 transfer function of the filter selected by the knob (thus summing the dB values of the two diagrams), a resulting distribution (S2), which is illustrated in FIG. 1d is obtained, having a zero at the origin, a double pole at 100 Hz and a zero at 1 KHz. Therefore, the resulting distribution (S2) enhances the sound also at low-mid frequencies (100 Hz to 1 KHz), altering the final tone of the sound.

The purpose of the present invention is to eliminate the drawbacks of the prior art by providing a processing system of a stereo acoustic signal suitable for reproducing the acoustic signal with higher fidelity and higher reality similarly to the perception of a user who is listening with speakers.

Another purpose is to provide such a processing system of a stereo acoustic signal that is reliable.

A further purpose is to provide such a processing system of a stereo acoustic signal that is practical, versatile, and suitable for being implemented in an audio headphone.

An additional purpose is to provide such a processing system of a stereo acoustic signal suitable for compensating for a bass deficiency in the sound due to problems of the sound recording system or of the sound diffusion system.

These purposes are achieved in accordance with the invention with the features of the appended independent claim.

Advantageous achievements of the invention appear from the dependent claims.

Further features of the invention will appear clearer from the following detailed description, referring to its purely illustrative and therefore not limiting embodiments, illustrated in the appended drawings, wherein:

FIG. 1a illustrates a sound distribution in the frequencies from a music piece from the 1960s with a typical deficiency of frequencies below 100 Hz;

FIG. 1b illustrates a family of Bode plots as a function of the position of the knob in a Baxandal tone control according to the prior art;

FIG. 1c shows a transfer function in the case where the knob of the Baxandal tone control is set to 100 Hz;

FIG. 1d shows a sound distribution resulting from multiplying the sound distribution of FIG. 1a by the transfer function of FIG. 1c;

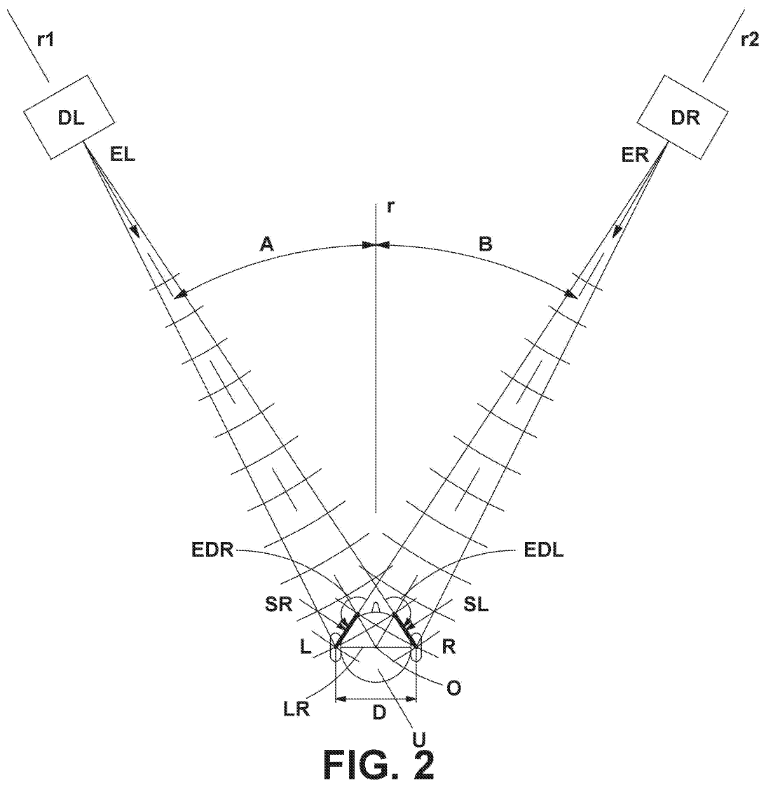

FIG. 2 is a schematic view illustrating two speakers emitting respective acoustic signals towards a listener;

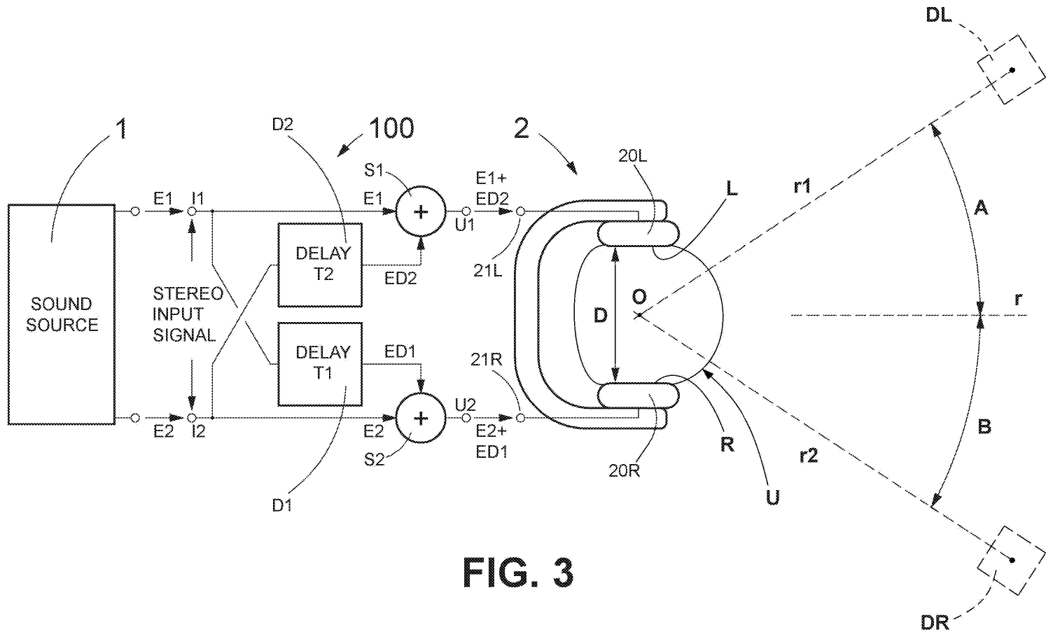

FIG. 3 is a block diagram of the processing system of a stereo acoustic signal according to the invention, in a basic version;

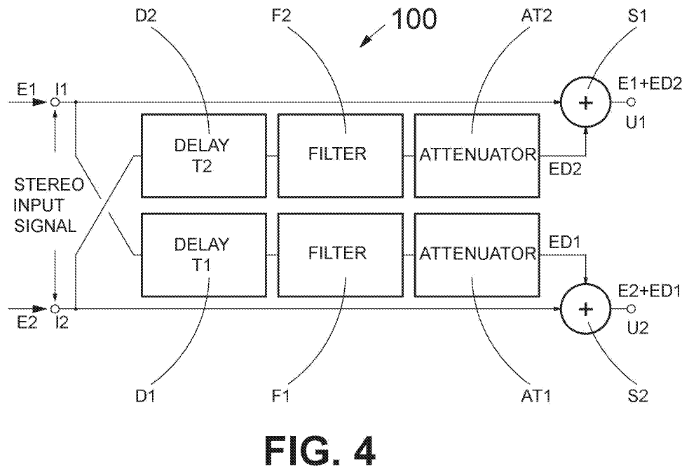

FIG. 4 is a block diagram of an improvement of the processing system of a stereo acoustic signal according to the invention, wherein low-pass filters and attenuators are added;

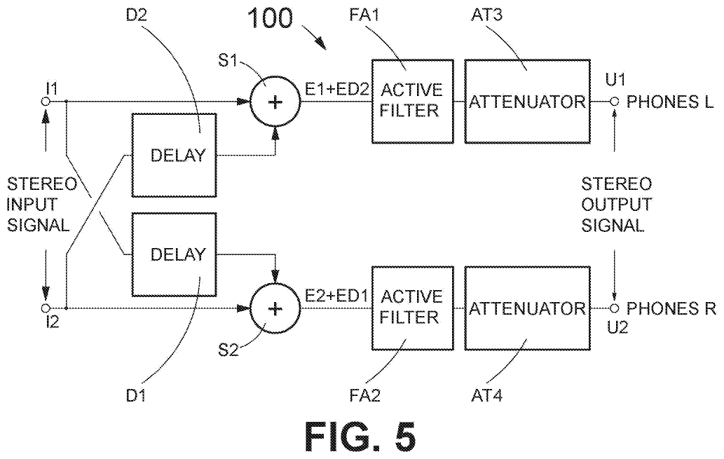

FIG. 5 is a block diagram of a further improvement of the processing system of a stereo acoustic signal according to the invention, wherein active filters and attenuators are added;

Similarly to FIG. 1a, FIG. 6a illustrates a sound distribution in the frequencies from a music piece from the 1960s with a typical deficiency at frequencies below 100 Hz;

FIG. 6b illustrates a family of Bode plots as a function of the position of the knob in an active filter according to the invention; and

FIG. 6c shows a transfer function in the case where the knob of the active filter was is set to 100 Hz;

FIG. 6d shows a sound distribution resulting from multiplying the sound distribution of FIG. 6a by the transfer function of FIG. 6c.

FIG. 2 shows a typical listening situation with speakers or loudspeakers in an anechoic chamber. In the anechoic chamber, there is a left speaker (DL) disposed to the left of a listener (U) and a right speaker (DR) disposed to the right of the listener (U).

The listener (U) has a left ear (L) and a right ear (R). A segment (LR) joining the left ear to the right ear is drawn on a plane (corresponding to the plane of the drawing sheet in FIG. 2). The segment (LR) has a center (O). A first straight line (r1) connects a center of the left speaker (DL) to the center (O) of the segment (LR). A second straight line (r2) connects a center of the right speaker (DR) to the center (O) of the segment (LR). A median straight line (r) passes through the center (O) of the segment (LR) and is orthogonal to the segment (LR).

A first angle (A) between the median straight line (r) and the first straight line (r1) defines an inclination of the left speaker (DL). A second angle (B) between the median straight line (r) and the second straight line (r2) defines an inclination of the right speaker (DR). The first angle (A) and the second angle (B) can vary from 0° to 90° depending on the position of the speakers relative to the listener (U).

The segment (LR) has a length (D) equal to the distance between the ears (L, R) of the listener, which generally ranges between 140 mm and 180 mm.

The left speaker (DL) emits a sound that first reaches the left ear (L) and then the right ear (R), which is obviously distant from the left speaker.

As a matter of fact, once the sound from the left speaker (DL) has reached the left ear, the sound must cover a left-to-right travel (SL) to reach the right ear. Such a left-to-right travel (SL) depends on the position of the left speaker (DL) and is given by the following equation:

$$SL = D * sin ( A )$$

In such a case, considering that the sound is propagated in the air, it can be assumed that the sound has an average speed (SS) of 343 m/s.

In order to cover the left-to-right travel (SL), the sound employs a left-to-right delay time (TL) given by the following equation:

$$TL = SL / SS$$

Similarly, the sound from the right speaker (DR) first reaches the right ear (D) and then the left ear (L).

Once the sound from the right speaker (DR) has reached the right ear, the sound must cover a right-to-left travel (SR) to reach the left ear. Such a right-to-left travel (SR) is given by the following equation:

$$SR = D * sin ( B )$$

In order to cover the right-to-left travel (SR), the sound employs a right-to-left delay time (TR) given by the following equation:

$$TR = SR / SS$$

The sound emitted from the left speaker and from the right speaker can be identified as an acoustic signal.

EL indicates a direct acoustic signal emitted by the left speaker (DL) that reaches the left ear (L) without any delay.

EDL indicates a delayed acoustic signal emitted by the left speaker (DL) that reaches the right ear (R) with the delay time (TL).

ER indicates a direct acoustic signal emitted by the right speaker (DR) that reaches the right ear (R) without any delay.

EDR indicates a delayed acoustic signal emitted by the right speaker (DR) that reaches the left ear (L) with the delay time (TR).

Thus, in the case of two speakers and one listener, the left ear (L) receives the direct acoustic signal (EL) from the left speaker and the delayed acoustic signal (EDR) from the right speaker; conversely, the right ear (R) receives the direct acoustic signal (ER) from the right speaker and the delayed acoustic signal (EDL) from the left speaker.

The purpose of the present invention is to simulate a sound condition like the one explained above in the right earpiece and in the left earpiece of an acoustic headphone.

With reference to FIG. 3, the system according to the invention, which is comprehensively indicated with numeral reference 100, is shown.

The system (100) is used to process a stereo acoustic signal in such a way that a listener (U) wearing an acoustic headphone (2) perceives a sound as coming from a left virtual speaker (DL) disposed to the left of the listener and from a right virtual speaker (DR) disposed to the right of the listener. Otherwise said, the left earpiece (20L) of the acoustic headphone should emit a sound similar to the sound that would be perceived by the listener in the case of a physical speaker disposed to the left of the listener. Obviously, such a speaker is not present in the system and is therefore referred to as the left virtual speaker (DL) and is indicated with a broken line in FIG. 3. Instead, the right earpiece (20R) of the acoustic headphone should emit a sound similar to the sound that would be perceived by the listener in the case of a physical speaker disposed to the right of the listener. Obviously, such a speaker is not present in the system and is therefore referred to as the right virtual speaker (DL) and is indicated with a broken line in FIG. 3.

The system (100) comprises:
a first input (11) and a second input (12) suitable for being connected to a sound source (1) suitable for sending a stereo electro-acoustic signal, and
a first output (U1) and a second output (U2) suitable for being connected to an acoustic headphone (2) comprising a left earpiece (20L) and a right earpiece (20R).

By way of example, the sound source (1) can be a CD player, a Hi-Fi system, an audio mixer, a smartphone, a tablet, and the like.

The stereo signal emitted by the sound source comprises a first acoustic signal (E1) sent to the first input (11) and a second acoustic signal (E2) sent to the second input (12). In the case of a stereo transmission with two speakers, the first acoustic signal (E1) is the signal to be sent to the left speaker, and the second acoustic signal (E2) is the signal to be sent to the right speaker.

The first input (11) is connected to an input of a first summing block (S1).

The second input (12) is connected to an input of a second summing block (S2).

The first input (11) is connected to a first delay block (D1) connected to the second summing block (S2). The first delay block (D1) imparts a first delay (T1) to the first acoustic signal (E1), in such a way to output a first delayed acoustic signal (ED1) from the first delay block (D1), which is summed with the second acoustic signal (E2). The second summing block (S2) has an output connected to the second output (U2) from which the second acoustic signal (E2) plus the first delayed acoustic signal (ED1) is output.

The second input (12) is connected to a second delay block (D2) connected to the first summing block (S1). The second delay block (D2) imparts a second delay (T2) to the second acoustic signal (E2), in such a way to output a second delayed acoustic signal (ED2) from the second delay block (D2), which is summed with the first acoustic signal (E1). The first summing block (S1) has an output connected to the first output (U1) from which the first acoustic signal (E1) plus the second delayed acoustic signal (ED2) is output.

In such a case, the first acoustic signal (E1) corresponds to the acoustic signal (EL) emitted by the left speaker (DL) in the example of FIG. 2, and the second input signal (E2) corresponds to the acoustic signal (ER) emitted by the right speaker (DR) in the example of FIG. 2.

The first delay block (D1) is suitably configured to obtain a first delay time (T1) that does not depend on the frequency of the signal, but depends on the position of the left virtual speaker (DL) relative to the listener (U) and on the distance (D) between the ears (L, R) of the listener. Otherwise said, once the position in which the listener wants to position the left virtual speaker (DL) and the distance (D) between the ears (L, R) of the listener are known, the first delay time (T1) is set, which remains constant as the frequency of the signal varies.

More precisely, the first delay time (T1) is equal to the time employed by the sound signal emitted by the left speaker (DL) to cover the left-to-right travel (SL).

$$T 1 = \frac{D * sin ( A )}{SS}$$

Given that the sound has an average velocity (SS) of 343 m/s, the first delay time (T1) is a function of the distance (D) between the ears of the listener and of the inclination angle (A) of the left speaker with respect to the listener. Thus, the first delay time (T1) is comprised between 0 when A=0° and D/343 when A=90°. Considering that D is generally 15 cm-18 cm, T1 can range from 0 μs to 525 μs.

The second delay block (D2) is suitably configured to obtain a second delay time (T2) that does not depend on the frequency of the signal, but depends on the position of the right virtual speaker (DR) relative to the listener (U) and on the distance (D) between the ears of the listener. Otherwise said, once the position where the listener wants to position the right virtual speaker (DR) and the distance between the ears of the listener are known, the second delay time (T2) is set, which remains constant as the signal frequency varies.

More precisely, the second delay time (T2) is equal to the time employed by the sound signal emitted by the right speaker to cover the right-to-left travel (SR) shown in FIG. 2.

$$T 2 = \frac{D * sin ( B )}{SS}$$

Given that the sound has an average speed (SS) of 343 m/s, the second delay time (T2) is a function of the distance between the ears of the listener and of the inclination angle (B) of the right speaker relative to the listener. Thus, the second delay time (T1) is comprised between 0 when B=0° and D/343 when B=90°. Considering that D is generally 15 cm-18 cm, T2 can range from 0 μs to 525 μs.

The delay blocks (D1, D2) are of adjustable type. Therefore the user can adjust the delay times (T1, T2) according to the distance between the ears and according to the inclination of the virtual speakers to be simulated.

The first output (U1) and the second output (U2) of the system (100) are connected to respective inputs (21L, 21R) of the headphone (2). The inputs (21L, 21R) of the headphone are connected to the left earpiece (20L) and to the right earpiece (20R), respectively. Thus, the left earpiece (20L) emits a sound given by the first acoustic signal (E1) plus the second delayed acoustic signal (ED2), whereas the right earpiece (20R) emits a sound given by the second acoustic signal (E2) plus the first delayed acoustic signal (ED1).

The sounds coming from the left earpiece (20L) and from the right earpiece (20R) reproduce the sound that would be perceived by a listener from a physical left earpiece and from a physical right earpiece positioned as set by the user, varying the delay times (T1, T2) of the first and of the second delay block (D1, D2).

Going back to FIG. 2, it should be considered that the delayed acoustic signal (EDL) that reaches the right ear from the left speaker may be deficient of and attenuated at high frequencies (higher than 2 KHz), as the left-to-right travel (SL) is hindered by the features of the face of the listener that cause the attenuation of said acoustic signal. Also the delayed acoustic signal (EDR) that reaches the left ear from the right speaker (DR) may be deficient of and attenuated at high frequencies, as the right-to-left travel (SR) is hindered by the features of the face of the listener.

With reference to FIG. 4, in order to solve such a drawback, advantageously, the system (100) comprises a first low-pass filter (F1) and a second low-pass filter (F2) disposed at outputs of the first delay block (D1) and of the second delay block (D2), respectively.

The first low-pass filter (F1) and the second low-pass filter (F2) cut off the high frequencies of the first delayed acoustic signal (ED1) and of the second delayed acoustic signal (ED2), respectively, in order to simulate an attenuation of high frequencies due to the fact that the first delayed acoustic signal (ED1) is hindered by the features of the face of the listener in the left-to-right travel (SL) and the second delayed acoustic signal (ED2) is hindered by the features of the face of the listener in the right-to-left cover (SR).

The first low-pass filter (F1) and the second low-pass filter (F2) have adjustable cut-off frequencies, which are adjusted according to the configuration of the left-to-right travel (SL) and of the right-to-left travel (SR). In any case, the cut-off frequency of the first low-pass filter (F1) and of the second low-pass filter (F2) can be set in a range from 900 Hz to 20,000 Hz, which corresponds to a null effect in the audible frequencies.

In addition to or in replacement of the first low-pass filter (F1) and of the second low-pass filter (F2), the system (100) comprises a first attenuator (AT1) and a second attenuator (AT2). In the case where the low-pass filters (F1, F2) are not provided, the first attenuator (AT1) and the second attenuator (AT2) are disposed at outputs of the first delay block (D1) and the second delay block (D2), respectively. In the case where low-pass filters (F1, F2) are provided, the first attenuator (AT1) and the second attenuator (AT2) are disposed at outputs of the first low-pass filter (F1) and of the second low-pass filter (F2), respectively.

The attenuators (AT1, AT2) attenuate the respective delayed acoustic signals (ED1, ED2) regardless of the frequency. The attenuators (AT1, AT2) simulate an attenuation of the delayed acoustic signals regardless of the frequency of the signals, which is due to the hindrance of the features of the face.

Referring to FIG. 5, the system (100) comprises a first active filter (FA1) disposed at the output of the first summing block (S1) and a second active filter (FA2) disposed at the output of the second summing block (S2). Therefore, the first active filter (FA1) acts on the first acoustic signal (E1) and on the second delayed acoustic signal (ED2). The second active filter (FA1) acts on the second acoustic signal (E2) and on the first delayed acoustic signal (ED1).

The function of the active filters (FA1, FA2) is to enhance the sound at low frequencies, in the case where the acoustic signals have deficiencies at low frequencies due, for example, to problems in the recording process.

The active filters (FA1, FA2) can be provided in the system (100) either in the presence or absence of the low-pass filters (F1, F2) and/or of the attenuators (AT2, AT3).

Advantageously, respective attenuators (AT3, AT4) are disposed at the output of the active filters (FA1, FA2) to attenuate the signals coming from the active filters regardless of their frequencies (volume attenuators).

The case is described where there is a sound distribution (S1) at the input of the active filter (FA1, FA2) in the frequencies from a music piece from the 1960s, with a typical deficiency of frequencies below 100 Hz, as shown in FIG. 6a.

Each active filter (FA1, FA2) has an adjustable knob to adjust the frequency range in which to enhance the sound signal. The active filter has a frequency response depending on the position of the knob, represented by a family of Bode plots, as shown in FIG. 6b.

Each Bode plot is a transfer function (G1, . . . , G12) of the first-order (6 db/octave) characterized by a pole at a fixed low frequency, e.g. a frequency comprised in the range from 15 Hz to 25 Hz, preferably 20 Hz, and a zero at a variable frequency depending on the position of the knob, e.g. at a frequency comprised in the range from 15 Hz to 1.2 KHz. The diagram of FIG. 6b illustrates 12 transfer functions (G1, . . . , G12) obtained with 12 positions of the knob.

In such a case, for illustrative purposes, if a sound deficiency at the frequencies below 100 Hz is to be compensated in the sound distribution (S1) of FIG. 6a, the knob is set at 100 Hz, so as to enhance the sound at the low frequencies below 100 Hz. In such a case, a filter is generated having the transfer function (G5) shown in FIG. 6c, wherein said transfer function (G5) is equal to zero dB for frequencies higher than 100 Hz.

From the transfer functions of the diagram of FIG. 6b, the transfer function (G5) illustrated in FIG. 6c, which has a zero at 100 HZ, is selected. Otherwise said, a transfer function having a zero at 100 Hz, a pole at 20 Hz, and a constant gain of 5x (about 14 dB) for frequencies below 20 Hz is selected.

In such a case, multiplying the sound distribution (S1) of FIG. 6a by the transfer function (G5) of the filter shown in FIG. 6c, the resulting sound distribution (S2) shown in FIG. 6d is obtained, which is equal to zero dB for frequencies higher than 20 Hz. Therefore, the resulting sound distribution (S2) provides a sound enhancement only at the low frequencies above 20 Hz and below 100 Hz.

In such a case, a sound compensation is achieved only at the low frequencies, without altering the sound tone, as it can be seen from the sound distribution (S2) in FIG. 6d.

Numerous equivalent variations and modifications may be made to the present embodiments of the invention, which are within the reach of a person skilled in the art, but still within the scope of the invention as expressed by the appended claims.

1. System for processing a stereo acoustic signal in such a way that a listener wearing an
acoustic headphone perceives a sound as coming from a left virtual speaker disposed at the left of the listener and from a right virtual speaker disposed at the right of the listener; said system comprising:
a first input and a second input suitable for being connected to a sound source capable of sending a stereo electroacoustic signal comprising a first acoustic signal suitable for being sent to the first input, and a second acoustic signal suitable for being sent to the second input,
a first output and a second output suitable for being connected to an acoustic headphone comprising a left earpiece and a right earpiece,
a first summing block having an input connected to the first input and an output connected to the first output,
a second summing block having an input connected to the second input and an output connected to the second output,
a first delay block connected to the first input and to the second summing block, in such a way to impart a first delay time to the first acoustic signal, so as to obtain a first delayed acoustic signal in output from the first delay block, said first delayed acoustic signal being summed to the second acoustic signal sent to the second input in the second summing block; and
a second delay block connected to the second input and to the first summing block, in such a way to impart a second delay time to the second acoustic signal, so as to obtain a second delayed acoustic signal in output from the second delayed block, said second delayed acoustic signal being summed to the first acoustic signal sent to the first input in the first summing block
characterized in that
said first delay block is connected to the first input to impart a first delay time to the first acoustic signal sent to the first input and is suitably configured to generate a first delay time independent from the signal frequency, the first delay time remaining constant as to the frequency of the signal varies and being adjustable according to a distance between the ears of the listener and a position of said left virtual speaker with respect to the listener; and
said second delay block is connected to the second input to impart a second delay time to the second acoustic signal sent to the second input and is suitably configured to generate a second delay time independent from the signal frequency and adjustable according to a distance between the ears of the listener and a position of said right virtual speaker with respect to the listener.

2. The system according to claim 1, wherein the position of said left virtual speaker with respect to the listener is defined by a first inclination angle of said left virtual speaker with respect to the listener; and the position of said right virtual speaker with respect to the listener is defined by a second inclination angle of said right virtual speaker with respect to a listener;
wherein the listener has a left ear and a right ear, considering a segment joining the left ear to the right ear; the segment having a center, a first straight line connects a center of the left virtual speaker to the center of the segment; a second straight line connects a center of the right virtual speaker to the center of the segment, a median straight line passes through the center of the segment and is orthogonal to the segment;
wherein said first angle between the median straight line and the first straight line defines an inclination of the left virtual speaker and said second angle between the median straight line and the second straight line defines an inclination of the right virtual speaker.

3. The system according to claim 2, wherein said first delay time of the first delay block is given by the following equation:
$$T 1 = \frac{D * sin ( A )}{SS}$$
wherein
D=distance between the ears of the listener;
A=first inclination angle of the left virtual speaker relative to the listener;
SS=average speed of the sound in the air;
wherein said second delay time of the second delay block is given by the following equation:
$$T 2 = \frac{D * sin ( B )}{SS}$$
wherein
D=distance between the ears of the listener;
B=second inclination angle of the right virtual speaker relative to the listener;
SS=average speed of the sound in the air.

4. The system according to claim 1, comprising a first low-pass filter and a second low-pass filter disposed at the outputs of the first delay block and of the second delay block, respectively; said first low-pass filter and second low-pass filter being configured to cut off the high frequencies of the first delayed acoustic signal and of the second delayed acoustic signal, respectively.

5. The system according to claim 4, wherein said first low-pass filter and second low-pass filter are adjustable cut-off frequency filters, and the cut-off frequency of the first low-pass filter and of the second low-pass filter can be adjusted in a range from 900 Hz to 20,000 Hz in such a way to cut off the high frequencies.

6. The system according to claim 1, comprising a first attenuator and a second attenuator disposed at the outputs of the first delay block and of the second delay block, respectively; said first attenuator and second attenuator being configured to attenuate the first delayed acoustic signal and the second delayed acoustic signal, respectively, regardless of the frequency.

7. The system according to claim 1, comprising a first active filter disposed at the output of the first summing block and a second active filter disposed at the output of the second summing block; wherein the first active filter acts on the first acoustic signal and on the second delayed acoustic signal, and the second active filter acts on the second acoustic signal and on the first delayed acoustic signal; wherein each active filter is configured to enhance the sound at low frequencies.

8. The system according to claim 7, wherein each active filter has an adjustable knob for selecting a frequency range in which the sound signal is to be enhanced; each active filter has a frequency response as a function of the position of the knob, represented by a family of Bode plots wherein each Bode plot is a transfer function of the first order characterized by a pole at a fixed low frequency and a zero at a variable frequency as a function of the position of the knob.

9. The system according to claim 8, wherein said pole of each transfer function of each active filter is at a frequency comprised in the range from 15 Hz to 25 Hz, preferably 20 Hz, and said zero of each transfer function of each active filter is at a frequency comprised in the range from 15 Hz to 1.2 KHz.
